(19) United States
(12) Patent Application Publication
(10) Pub. No.: US 2023/0127181 A1
(43) Pub. Date: Apr. 27, 2023

(54) OPTICAL SENSOR

(71) Applicant: Japan Display Inc., Tokyo (JP)

(72) Inventor: Tomoyuki ITO, Tokyo (JP)

(73) Assignee: Japan Display Inc., Tokyo (JP)

(21) Appl. No.: 17/974,601

(22) Filed: Oct. 27, 2022

(30) Foreign Application Priority Data
Oct. 27, 2021 (JP) 2021-175702

(51) Int. Cl. G06V 40/13; G06V 10/143; G06V 10/147

(52) U.S. Cl. CPC G06V 40/1324; G06V 10/143; G06V 10/147

(57) ABSTRACT

According to one embodiment, an optical sensor includes a display panel and a sensor panel under at least a part of the display panel. The display panel includes pixels arranged two-dimensionally. The sensor panel includes a sensor layer including sensor elements arranged two-dimensionally, a collimator layer on the sensor layer including openings, and lenses on the collimator layer. A first number of openings in the openings are on one of the sensor elements. The first number of lenses in the lenses are on the first number of openings. The first number of lenses are at positions different for each of the sensor elements.

### CROSS-REFERENCE TO RELATED APPLICATIONS

This application is based upon and claims the benefit of priority from Japanese Patent Application No. 2021-175702, filed Oct. 27, 2021, the entire contents of which are incorporated herein by reference.

### FIELD

Embodiments described herein relate generally to an optical sensor.

### BACKGROUND

In known optical sensors, a sensor panel is arranged under at least a part of a display panel for displaying images. The sensor panel captures an image of a finger or the like and detects biological information such as a fingerprint. The display panel emits illumination light. The illumination light is reflected on a finger in contact with or in proximity to the display panel. The reflected light passes through the display panel to be made incident on the sensor panel. The image of the finger is generated from the light incident on the sensor panel. The biological information such as the fingerprint is detected from the image.

The display panel includes a number of pixels arrayed in a two-dimensional matrix. The sensor panel includes a number of sensor elements SS arrayed in a two-dimensional matrix. The arrangement cycle of the pixels does not correspond to the arrangement cycle of the sensor elements SS. Periodic noise is generated in the image detected by the sensor panel. The detection accuracy of the biological information is degraded due to interference between the pixels and the sensor elements SS.

### BRIEF DESCRIPTION OF THE DRAWINGS

FIG. 1 is an exploded perspective view illustrating an example of an optical sensor according to a first embodiment.

FIG. 2 is a cross-sectional view illustrating an example of a sensor panel according to the first embodiment.

FIG. 3 is a plan view illustrating a sensor element according to the first embodiment.

FIG. 4 is a plan view illustrating an example of the sensor panel according to the first embodiment.

FIG. 5 is a cross-sectional view illustrating an example of the optical sensor according to the first embodiment.

FIG. 6 is a schematic cross-sectional view illustrating a first example of an intensity distribution of incident light according to the first embodiment.

FIG. 7A is a waveform chart illustrating a first example of the intensity distribution of the incident light according to the first embodiment.

FIG. 7B is a waveform chart illustrating the first example of the intensity distribution of the incident light according to the first embodiment.

FIG. 7C is a waveform chart illustrating the first example of the intensity distribution of the incident light according to the first embodiment.

FIG. 8 is a schematic cross-sectional view illustrating a second example of the intensity distribution of the incident light according to the first embodiment.

FIG. 9A is a waveform chart illustrating a second example of the intensity distribution of the incident light according to the first embodiment.

FIG. 9B is a waveform chart illustrating the second example of the intensity distribution of the incident light according to the first embodiment.

FIG. 9C is a waveform chart illustrating the second example of the intensity distribution of the incident light according to the first embodiment.

FIG. 10 is a schematic cross-sectional view illustrating a third example of the intensity distribution of the incident light according to the first embodiment.

FIG. 11A is a waveform chart illustrating a third example of the intensity distribution of the incident light according to the first embodiment.

FIG. 11B is a waveform chart illustrating the third example of the intensity distribution of the incident light according to the first embodiment.

FIG. 11C is a waveform chart illustrating the third example of the intensity distribution of the incident light according to the first embodiment.

FIG. 12 is a plan view illustrating a first example of the arrangement pattern of the lenses according to the first embodiment.

FIG. 13 is a plan view illustrating a second example of the arrangement pattern of the lenses according to the first embodiment.

FIG. 14 is a plan view illustrating a third example of the arrangement pattern of the lenses according to the first embodiment.

FIG. 15 is a plan view illustrating a fourth example of the arrangement pattern of the lenses according to the first embodiment.

FIG. 16 is a plan view illustrating a fifth example of the arrangement pattern of the lenses according to the first embodiment.

FIG. 17 is a plan view illustrating a sixth example of the arrangement pattern of the lenses according to the first embodiment.

FIG. 18 is a cross-sectional view illustrating an example of an optical sensor according to a second embodiment.

FIG. 19 is a cross-sectional view illustrating an example of a sensor panel according to the second embodiment.

FIG. 20 is a plan view illustrating a first example of the arrangement of the color filters according to a third embodiment.

FIG. 21 is a plan view illustrating a second example of the arrangement of the color filters according to the third embodiment.

FIG. 22 is a plan view illustrating a third example of the arrangement of the color filters according to the third embodiment.

### DETAILED DESCRIPTION

Various embodiments will be described hereinafter with reference to the accompanying drawings.

The disclosure is merely an example and is not limited by contents described in the embodiments described below. Modification which is easily conceivable by a person of ordinary skill in the art comes within the scope of the disclosure as a matter of course. In order to make the description clearer, the sizes, shapes, and the like of the respective parts may be changed and illustrated schematically in the drawings as compared with those in an accurate representation. Constituent elements corresponding to each other in a plurality of drawings are denoted by like reference numerals and their detailed descriptions may be omitted unless necessary.

In general, according to one embodiment, an optical sensor comprises a display panel and a sensor panel under at least a part of the display panel. The display panel comprises pixels arranged two-dimensionally. The sensor panel comprises a sensor layer including sensor elements arranged two-dimensionally, a collimator layer on the sensor layer comprising openings, and lenses on the collimator layer. A first number of openings in the openings are on the sensor elements. The first number of lenses in the lenses are on the first number of openings. The first number of lenses are at positions different for each of the sensor elements.

### First Embodiment

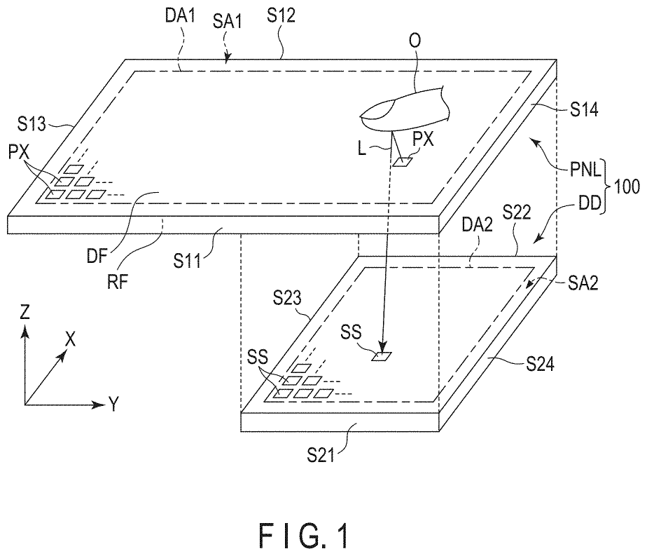

FIG. 1 is an exploded perspective view illustrating an example of an optical sensor 100 according to a first embodiment. In the optical sensor 100, a first direction X, a second direction Y, and a third direction Z are defined. In the example illustrated in FIG. 1, the first direction X, the second direction Y, and the third direction Z are orthogonal to each other. These directions may intersect at an angle other than 90 degrees. The first direction X and the second direction Y correspond to the directions parallel to the main surface of a substrate included in the optical sensor 100, and the third direction Z corresponds to the thickness direction of the optical sensor 100 or the stacking direction of layers included in the optical sensor 100. The first direction X and the second direction Y are defined for convenience. The first direction may be referred to as Y and the second direction may be referred to as X. In the specification, a direction toward a tip of an arrow indicating the third direction Z is referred to as an upward direction, and its opposite direction is referred to as a downward direction. In addition, viewing the optical sensor 100 and its components by a line of sight parallel to the third direction Z is referred to as a plan view.

The optical sensor 100 comprises a display panel PNL and a sensor panel DD. The display panel PNL and the sensor panel DD overlap in the third direction Z. In FIG. 1, the display panel PNL and the sensor panel DD are separated for convenience of illustration, but, actually, the display panel PNL and sensor panel DD are bonded together as illustrated in FIG. 5.

The display panel PNL has a rectangular shape with a first side S11 along the second direction Y, a second side S12 along the second direction Y, a third side S13 along the first direction X, and a fourth side S14 along the first direction X. In FIG. 1, the first side S11 and the second side S12 are long sides and the third side S13 and the fourth side S14 are short sides. The first side S11 and the second side S12 may be short sides and the third side S13 and the fourth side S14 may be long sides. Furthermore, the shape of the display panel PNL is not limited to a rectangular shape. The shape of the display panel PNL may be other shapes such as a square, polygonal, or circular shape.

The display panel PNL includes a display area DA1 and a peripheral area SA1 around the display area DA1. The display area DA1 includes pixels PX arrayed in a matrix in the first direction X and the second direction Y. The planar shape of the pixels is a square or rectangular shape. The pixel PX may comprise a red sub-pixel, a green sub-pixel, and a blue sub-pixel. The pixel PX may further include sub-pixels of the other color such as a white color. One of examples of the pixels is an organic electroluminescent (EL) display element. The other examples of pixels are a liquid crystal display element and an LED display element.

The display panel PAIL has a display surface DF on which images are displayed and a back surface RF on a side opposite to the display surface DF. Both the display surface DF and the back surface RF are planes parallel to the first direction X and the second direction Y.

The sensor panel DD has a rectangular shape with a first side S21 along the second direction Y, a second side S22 along the second direction Y, a third side S23 along the first direction X, and a fourth side S24 along the first direction X. In FIG. 1, the first side S21 and the second side S22 are short sides and the third side S23 and the fourth side S24 are long sides. The first side S21 and the second side S22 may be long sides and the third side S23 and the fourth side S24 may be short sides. The shape of the sensor panel DD is not limited to a rectangular shape. The shape of the sensor panel DD may be other shapes such as a square, polygonal, or circular shape.

The sensor panel DD includes a display area DA2 and a peripheral area SA2 around the display area DA2. The display area DA2 includes sensor elements SS arrayed in a two-dimensional matrix in the first direction X and the second direction Y. The sensor elements SS are the elements that detect light. The planar shape of the sensor elements SS is a square or rectangular shape.

The sensor panel DD is attached to the back surface RF of the display panel PNL. The size of the sensor panel DD is set to any size and may be the same size as the display panel PNL or smaller than the display panel PNL. The position of the sensor panel DD attached to the display panel PNL is any position. The sensor panel DD may be attached such that at least one of sides of the display panel PNL is aligned with at least one of sides of the display panel PNL or is not aligned with at least one of sides of the display panel PNL. In FIG. 1, the sensor panel DD is smaller than the display panel PNL and the sensor panel DD is attached to the display panel PNL such that a side of the sensor panel DD is aligned with a side of the display panel PNL. More specifically, the first side S21 and the second side S22 of the sensor panel DD are shorter than the first side S11 and the second side S12 of the display panel PNL, and the third side S23 and the fourth side S24 of the sensor panel DD have the same length as the third side S13 and the fourth side S14 of the display panel PNL. The sensor panel DD is attached to the display panel PNL such that the fourth side S24 of the sensor panel DD is aligned with the fourth side S14 of the display panel PNL at the same position.

The sensor panel DD overlaps with a part close to the fourth side S14 in the display panel PNL in the third direction Z. In other words, the detection area DA2 overlaps with a portion close to the fourth side S14 in the display area DA1. The manner in which the sensor panel DD overlaps with the display panel PNL (the manner in which the detection area DA2 overlaps with the display area DA1) is not limited to the example illustrated in FIG. 1. When the sensor panel DD has the same size as the display panel PNL, the detection area DA2 overlaps with the entire display area DA1.

When the optical sensor is used as a display device, i.e., when an image is displayed, the pixels PX emit light according to the image. When the optical sensor is used as its original purpose, i.e., at the sensing, the pixels PX emit illumination light for sensing from the display surface DF. At the sensing, the red sub-pixel, the green sub-pixel, and the blue sub-pixel are all turned on simultaneously to emit white illumination light. The illumination light is reflected on an object O such as a user's finger, which is in contact with or close to the display surface DF. Reflected light L on the object O is transmitted through the display panel PNL and is made incident on the sensor elements SS. The sensor elements SS output detection signals corresponding to the incident reflected light L. The sensor panel DD can detect the object O which is in contact with or close to the display surface DF, based on the detection signals. In addition, the sensor panel DD can detect unevenness (for example, a fingerprint) on the surface of the object O, by using the detection signals of the sensor elements SS.

The sensor panel DD can also detect information on living bodies, based on the light reflected inside the object O instead of detection of the fingerprint or in addition to detection of the fingerprint. The information on living bodies is, for example, the images of blood vessels such as veins, pulse rates, pulse waves, and blood flows.

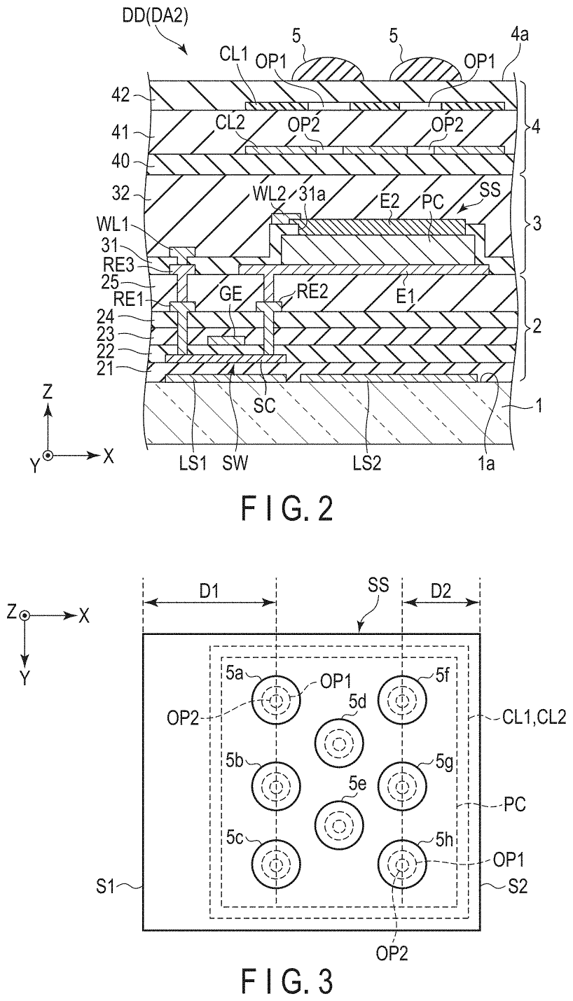

FIG. 2 is a cross-sectional view illustrating an example of the sensor panel DD according to the first embodiment. FIG. 2 illustrates a structure of one sensor element SS. The sensor panel DD comprises a base material 1, a circuit layer 2, a sensor layer 3, a collimator layer 4, and lenses 5. The base material 1, the circuit layer 2, the sensor layer 3, the collimator layer 4, and the lenses 5 are stacked in this order from bottom to top in the third direction Z (stacking direction).

Glass or resin substrates may be used as the base material 1. The circuit layer 2 comprises insulating layers 21, 22, 23, 24, and 25 stacked from bottom to top in the third direction Z. The sensor layer 3 comprises insulating layers 31 and 32 stacked in order from bottom in the third direction Z. The collimator layer 4 comprises transparent layers 41 and 42 stacked in order from bottom in the third direction Z. The transparent layers 41 and 42 are also referred to as insulating layers.

The insulating layers 21, 22, 23, 24, and 31 may be formed of inorganic materials. The insulating layers 25 and 32 may be formed of organic materials and serve as planarization films. The thickness of the insulating layers 25 and 32 is larger than that of the insulating layers 21, 22, 23, 24, and 31. The transparent layers 41 and 42 are formed of organic materials. In FIG. 2, the thickness of the transparent layer 41 is larger than that of that of the transparent layer 42. At least one of the transparent layers 41 and 42 may be formed of an inorganic material or formed of a laminate of a layer formed of an organic material and a layer formed of an inorganic material.

The collimator layer 4 further comprises a cut layer 40 that blocks light in a specific wavelength range. The specific wavelength range is so-called an infrared wavelength range, for example, 650 nm or more and 800 nm or less. The specific wavelength range may further include a range of 800 nm or more. In other words, the cut layer 40 blocks at least part of the light in the wavelength range of 650 nm or more. The cut layer 40 may be formed of a material with a lower light transmittance in the specific wavelength range (i.e., a material with a higher absorption or a higher reflectance of light in the specific wavelength range) than the insulating layer 32, the transparent layers 41 and 42, and the lenses 5. The cut layer 40 may be a band-pass filter using a dielectric multilayer film including dielectrics with different refractive indices. In this case, the transmittance of visible light in the cut layer 40 is improved. In FIG. 2, the cut layer 40 is located between the insulating layer 32 and the transparent layer 41. However, the position of the cut layer 40 is not limited to this example. In addition, the insulating layer 32 may comprise a function of blocking light in a specific wavelength range as well as the cut layer 40.

The circuit layer 2 comprises light-shielding layers LS1 and LS2, a switching element SW (thin-film transistor), and relay electrodes RE1 and RE2. The light-shielding layers LS1 and LS2 are arranged on an upper surface 1a of the base material 1 and covered with the insulating layer 21. The light-shielding layers LS1 and LS2 may be formed of a metallic material and have light-shielding properties.

The switching element SW comprises a semiconductor layer SC and a gate electrode GE. The semiconductor layer SC is arranged between the insulating layers 21 and 22 and is opposed to the light-shielding layer LS1. The gate electrode GE is arranged between the insulating layers 21 and 22 and is opposed to the semiconductor layer SC. Each of the relay electrodes RE1 and RE2 is arranged between the insulating layers 24 and 25, and is in contact with the semiconductor layer SC through contact holes that penetrate the insulating layers 22, 23, and 24.

The sensor layer 3 comprises sensor elements SS, wirings WL1 and WL2, and relay electrodes RE3. The sensor element SS comprises a first electrode E1 (lower electrode), a second electrode E2 (upper electrode), and a photoelectric conversion element PC.

The relay electrode RE3 is arranged between the insulating layers 25 and 31 and is in contact with the relay electrode RE1 through the contact hole that penetrates the insulating layer 25. The wiring WL1 is arranged between the insulating layers 31 and 32 and is in contact with the relay electrode RE3 through the contact hole that penetrates the insulating layer 31.

The first electrode E1 is arranged between the insulating layers 25 and 31 and is in contact with the relay electrode RE2 through the contact hole that penetrates the insulating layer 25. The photoelectric conversion element PC is arranged on the first electrode E1. A lower surface of the photoelectric conversion element PC is in contact with the first electrode E1. The photoelectric conversion element PC is opposed to the light-shielding layer LS2.

The insulating layer 31 includes an opening 31a that exposes at least a part of the upper surface of the photoelectric conversion element PC. The second electrode E2 is arranged between the photoelectric conversion element PC and the insulating layer 32. The second electrode E2 is in contact with an upper surface of the photoelectric conversion element PC through the opening 31a. A part of the second electrode E2 is located on the insulating layer 31. The wiring WL2 is arranged between the insulating layers 31 and 32 and is in contact with the second electrode E2.

The relay electrodes RE1, RE2, and RE3, the wirings WL1 and WL2, and the first electrode E1 may be formed of metal materials. The second electrode E2 may be formed of a transparent conductive material such as Indium Tin Oxide (ITO). The first electrode E1 formed of a metallic material also functions as a light-shielding layer and suppresses the incidence of the light from below into the photoelectric conversion element PC.

The photoelectric conversion element PC may be a photodiode, which outputs an electrical signal (detection signal) in response to incident light. More specifically, a PIN diode can be used as the photoelectric conversion element PC. This type of photodiode includes a p-type semiconductor layer, an i-type semiconductor layer, and an n-type semiconductor layer. The p-type semiconductor layer is located on the second electrode E2 side, the n-type semiconductor layer is located on the first electrode E1 side, and the i-type semiconductor layer is located between the p-type semiconductor layer and the n-type semiconductor layer. The p-type semiconductor layer, the i-type semiconductor layer, and the n-type semiconductor layer are formed of amorphous silicon (a-Si), but are not limited to this example.

A certain voltage may be supplied to the wiring WL2. A scanning signal is supplied to the gate electrode GE at the timing at which detection using the sensor element SS is to be performed. When the scanning signal is supplied to the gate electrode GE, the detection signal generated at the photoelectric conversion element PC is transmitted to the wiring WL1 via the first electrode E1, the relay electrode R2, the semiconductor layer SC, and the relay electrodes R1 and R3.

The collimator layer 4 further comprises collimators CL1 and CL2. The collimator CL1 is arranged between the transparent layers 41 and 42. The collimator CL2 is arranged between the cut layer 40 and the transparent layer 41. The collimator CL1 may be formed of a black resin and the collimator CL2 may be formed of a metal material.

Both the collimators CL1 and CL2 are opposed to the sensor element SS. The collimator CL1 includes openings OP1. The collimator CL2 includes the same number of openings OP2 as the openings OP1. A width (diameter) of the openings OP2 is smaller than that of the openings OP1. The openings OP1 and OP2 overlap with the cut layer 40 in the third direction Z.

The lenses 5 are arranged on an upper surface 4a of the collimator layer 4 (i.e., an upper surface of the transparent layer 42) at positions corresponding to the openings OP1, respectively. The lenses 5 may have a hemispherical shape convex upward in the third direction Z, and may be formed of a transparent material with a refractive index higher than that of the transparent layers 41 and 42. A height of the lenses 5 may be 2 to 12 μm.

The lenses 5 condense the light applied from the pixels PX illustrated in FIG. 1 and reflected on the object O. The condensed light is made incident on the photoelectric conversion element PC through the openings OP1 and OP2. The collimators CL1 and CL2 collimates the light incident on sensor panel DD. In other words, the light inclined to the third direction Z is blocked by the collimators CL1 and CL2. The detection accuracy of the sensor element SS can be thereby enhanced.

The collimator layer 4 may comprise only one of the collimators CL1 and CL2. In addition, the collimator layer 4 may comprise three or more collimators that overlap in the third direction Z.

FIG. 3 is a plan view illustrating the sensor element SS to illustrate an example of arrangement of the lenses 5, the collimators CL1 and CL2, and the photoelectric conversion element PC in one sensor element SS of the sensor panel DD according to the first embodiment. In FIG. 3, the photoelectric conversion element PC and the collimators CL1 and CL2 have a substantially square shape. The shape of the photoelectric conversion element PC and collimators CL1 and CL2 is not limited to this example and may be a rectangular shape. The collimators CL1 and CL2 do not need to be formed separately for each sensor element SS. The collimators CL1 and CL2 may be formed to overlap with sensor elements SS.

The first number of lenses 5 are arranged for one sensor element SS. The first number may be single or plural. FIG. 3 illustrates an example that the first number is plural, for example, eight. Eight lenses 5a, 5b, 5c, 5d, 5e, 5f, 5g, and 5h (collectively referred to as lenses 5 unless needed to be distinguished) are arranged for one sensor element SS. The openings OP1 and OP2 are arranged at the positions overlapping with the respective lenses 5 of the collimators CL1 and CL2. The shape of the openings OP1 and OP2 is not limited to a circular shape. The shape of the openings OP1 and OP2 may be other shapes such as a polygonal shape. A diameter of the lenses 5 is larger than that of the openings OP1 and OP2. The diameter of the lenses 5 may be in a range of 5 to 50 μm.

The lenses 5a, 5b, and 5c are arranged along the second direction Y. The lenses 5f, 5g, and 5h are arranged along the second direction Y. The lenses 5d and 5e are arranged between the line of lenses 5a, 5b, and 5c and the line of lenses 5f, 5g, and 5h. The distance between the line of lenses 5a, 5b, and 5c and the line of lenses 5d and 5e is equal to the distance between the line of lenses 5f, 5g, and 5h and the line of lenses 5d and 5e. The position of the lens 5a in the second direction Y is equal to the position of the lens 5f in the second direction Y. The position of the lens 5b in the second direction Y is equal to the position of the lens 5g in the second direction Y. The position of the lens 5c in the second direction Y is equal to the position of the lens 5h in the second direction Y. In the sensor element SS, the lenses 5 and the openings OP1 and OP2 are arranged such that as many lenses 5 and openings OP1 and OP2 as possible are arranged to implement high density.

The position of the lens 5d in the second direction Y is a middle point between the positions of the lenses 5a and 5b in the second direction Y (or a middle point of the positions of the lenses 5f and 5g in the second direction Y). The position of the lens 5e in the second direction Y is a middle point between the positions of the lenses 5b and 5c in the second direction Y (or a middle point of the positions of the lenses 5g and 5h in the second direction Y).

A distance D1 between the lenses 5a, 5b, and 5c and the first side S1 of the sensor element SS along the second direction Y is larger than a distance D2 between the lenses 5f, 5g, and 5h and the second side S2 of the sensor element SS along the second direction Y. The positions of the lenses 5d and 5e in the first direction X are shifted from the center of the sensor element SS in the first direction X to the second side S2 of the sensor element SS. In other words, the lenses 5 as a whole are arranged closely to the second side S2 of the sensor element. Since the openings OP1 and OP2 are arranged under the lenses 5, the openings OP1 and OP2 are also arranged as a whole closely to the second side S2 of the sensor element SS.

The arrangement of the lenses 5 and the openings OP1 and OP2 in one sensor element SS is not limited to the example of FIG. 3. In addition, the first number, which is the number of lenses 5 and the openings OP1 and OP2 arranged in one sensor element SS, is not limited to eight. The first number may be less than eight or more than eight. The number of lenses 5 and openings OP1, OP2 may be singular, depending on the pixel size.

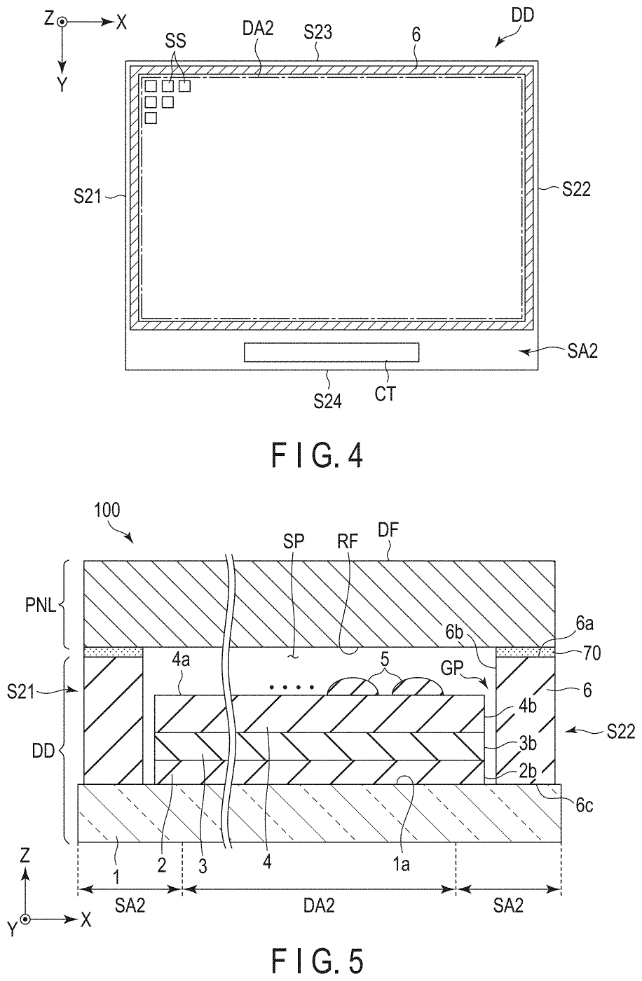

FIG. 4 is a plan view illustrating an example of the sensor panel DD according to the first embodiment. The sensor panel DD comprises a spacer 6. The spacer 6 is arranged in the peripheral area SA2. In the embodiment, the spacer 6 is shaped a frame that surrounds the detection area DA2. The spacer 6 surrounds the lenses 5 arranged in the detection area DA2.

In the example of FIG. 4, a controller CT is mounted between the detection area DA2 and the fourth side S24. The controller CT may be an IC. The sensor element SS is connected to the controller CT via the wiring WL1 (see FIG. 2). The controller CT may be mounted on a printed circuit board or the like that connects the sensor panel DD to an external circuit.

FIG. 5 is a cross-sectional view illustrating an example of the optical sensor according to the first embodiment. FIG. 5 illustrates a schematic configuration of the optical sensor 100 along the X-Z plane defined by the first direction X and the third direction Z. Although omitted in FIG. 5, the display panel PNL may include a transparent base material, a drive circuit formed for each pixel PX, an organic EL display element connected to the drive circuit, a sealing layer covering the organic EL display element, a polarizer, and a cover member such as a glass substrate that constitutes an uppermost surface.

The spacer 6 has an upper surface 6a, a side surface 6b (inner peripheral surface), and a lower surface 6c. In the embodiment, the lower surface 6c is in contact with the upper surface 1a of the base material 1.

The circuit layer 2 has a side surface 2b opposed to the spacer 6. The sensor layer 3 has a side surface 3b opposed to the spacer 6. The collimator layer 4 has a side surface 4b opposed to the spacer 6. In the embodiment, a gap GP is formed between the sides 2b, 3b, and 4b and the side surface 6b. The gap GP is located in the peripheral area SA2, and has an annular shape surrounding the detection area DA2 in planar view.

The spacer 6 protrudes more upwardly in the third direction Z than each lens 5 arranged in the detection area DA2. In other words, the distance between the upper surface 6a and the lower surface 6c of the spacer 6 (height of the spacer 6) is larger than the apex of the lenses 5 and the upper surface 1a of the base material 1 in the third direction Z. The spacer 6 may be formed of an organic material and have insulating properties.

The display panel PNL and the sensor panel DD are bonded by an adhesive layer 70. In the embodiment, the adhesive layer 70 is arranged between the upper surface 6a of the spacer 6 and the back surface RF of the display panel PNL. The adhesive layer 70 has a frame shape in planar view, similarly to the spacer 6, and is located in the peripheral area SA2. The adhesive layer 70 does not overlap with the detection area DA2 in planar view. In other words, the adhesive layer 70 is not opposed to each lens 5.

By thus bonding the display panel PNL and the sensor panel DD, the space SP is formed between the display panel PNL and the sensor panel DD (more specifically, collimator layer 4). The space SP may be an air layer. Since the spacer 6 protrudes more upwardly in the third direction Z than the lenses 5, the lenses 5 are not in contact with the display panel PNL.

FIG. 5 illustrates the cross-sectional structure of the optical sensor 100 along the first direction X, and the same structure as that in FIG. 5 can also be applied to the cross-sectional structure of the optical sensor 100 along the second direction Y.

Since the sensor panel DD comprises the spacer 6 protruding more upwardly in the third direction Z than the lenses 5, the sensor panel DD can be attached to the display panel PNL by bonding the upper surface 6a of the spacer 6 to the back surface RF of the display panel PNL through the adhesive layer 70. In this attaching method, no special parts are required. The sensor panel DD can easily be attached to the display panel PNL and the size of the optical sensor 100 can be reduced.

In addition, the space SP is formed between the display panel PNL and the sensor panel DD by the spacer 6, and the lenses 5 are located in this space SP. Since the lenses 5 are not in contact with the display panel PNL, the optical function of the lenses 5 is not inhibited and the detection accuracy of the sensor element SS can be enhanced.

If the spacer 6 has a frame shape surrounding the detection area DA2 as illustrated in FIG. 4, the entire periphery of the detection area DA2 can be desirably bonded to the display panel PNL. In addition, a uniform space SP can be formed over the entire detection area DA2. In FIG. 5, the spacer 6 is integrally attached to the sensor panel DD. The spacer 6 may not be an integral spacer, but an external spacer. The external spacer may be attached to the sensor panel DD using an adhesive material, for example, glue tape.

Since the adhesive layer 70 is a frame shape surrounding the detection area DA2 and is not opposed to the lenses 5, the optical characteristics such as the refractive index of the adhesive layer 70 do not affect detection using the sensor element SS. The range of material selection for the adhesive layer 70 is expanded.

Next, the generation and prevention of periodic noise caused by interference between the pixels PX and the sensor elements SS in the optical sensor 100 of the embodiment will be described. When the arrangement cycle of the pixels PX does not correspond to the arrangement cycle of the sensor elements SS, the intensity of the light incident on the sensor elements SS is varied depending on the location. Periodic noise occurs in the image detected by the sensor panel. The detection accuracy of biological information is reduced, due to the interference between the pixels PX and the sensor elements SS.

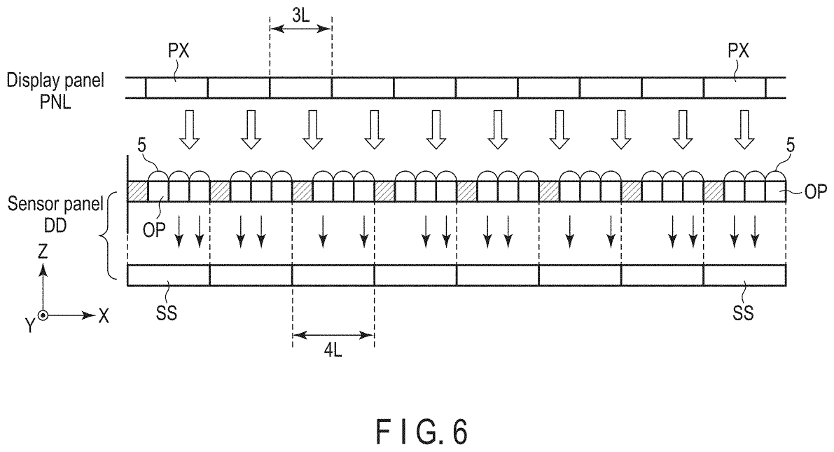

FIG. 6 is a schematic cross-sectional view illustrating a first example of the intensity distribution of the incident light in a case where the arrangement cycle of the pixels PX is different from the arrangement cycle of the sensor elements SS. FIG. 6 exemplarily illustrates that the intensity of the light incident on the sensor panel DD is varied depending on the position in the first direction X. The size of the pixel PX in the first direction X is referred to as 3L. The size of the sensor element SS in the first direction X is referred to as 4L. L is any positive number. The size of the pixel PX and the sensor element SS in second direction Y is set to any size.

As illustrated in FIG. 3, three lenses 5 are arranged in the first direction X for each sensor element SS of the sensor panel DD. Since FIG. 6 is a view illustrating the distribution of the intensity of the light incident on the sensor panel DD in the first direction X, the number of lenses arranged along the second direction Y in one sensor element SS is not limited to the example in FIG. 3, but is any number. The three lenses 5 arranged along the first direction X are not arranged in the center of the sensor element SS in the first direction X. The three lenses 5 are arranged closely to one of end sides of the sensor element SS in the first direction X. Three openings OP (OP1 and OP2) are arranged at positions corresponding to the three lenses 5, respectively, at the collimators CL (CL1 and CL2) arranged under the lenses 5.

For convenience of illustration, the display panel PNL includes adjacent pixels PX, but, actually, two adjacent pixels PX are spaced apart as illustrated in FIG. 1. The lenses 5 include three adjacent lenses 5, similarly to the pixels PX, but, actually, two adjacent lenses 5 are spaced apart as illustrated in FIG. 2. The openings OP include three adjacent openings OP, similarly to the lenses 5, but, actually, two adjacent openings OP are spaced apart as illustrated in FIG. 2. The sensor elements SS are also adjacent to each other but, actually, two adjacent sensor elements SS are spaced apart as illustrated in FIG. 1.

During the sensing, the illumination light emitted from the pixels PX is reflected on the object O, and the reflected light L is transmitted through the pixels PX of the display panel PNL, further transmitted through the lenses 5 and the openings OP and made incident on the sensor elements SS. Since the size of the pixel PX is different from the size of the sensor element SS, the arrangement cycle of the pixels PX is shifted from that of the sensor elements SS. The intensity of the light incident on the sensor panel DD is varied periodically depending on the position in the first direction X.

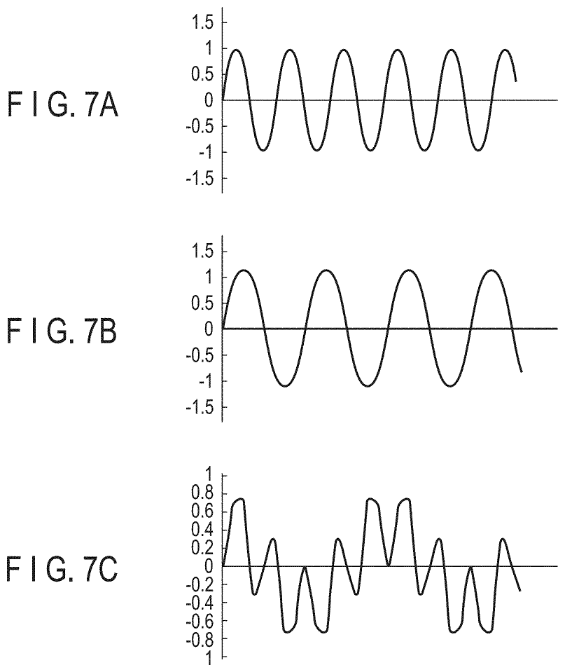

FIG. 7A, FIG. 7B, and FIG. 7C are waveform charts illustrating a first example of the intensity distribution of the incident light in a case where the pixels PX and the sensor elements SS are arranged as illustrated in FIG. 6. In FIG. 7A, FIG. 7B, and FIG. 7C, the vertical axis indicates the light intensity and the horizontal axis indicates the position in the first direction X. FIG. 7A is a chart illustrating the intensity variation of the light transmitted through the display panel PNL. Since the adjacent pixels PX are spaced apart from each other, the intensity of the light transmitted through the display panel PNL is varied periodically according to the arrangement cycle of the pixels PX. FIG. 7B is a chart illustrating the light transmittance of the collimator CL alone. The intensity of the light transmitted through the collimator CL is varied periodically according to the arrangement cycle of the three openings OP. FIG. 7C is a chart illustrating the intensity variation of the light incident on the sensor elements SS in a case where the transmitted light of the display panel PNL indicating the intensity distribution as illustrated in FIG. 7A is transmitted through the collimator having the transmittance as illustrated in FIG. 7B. As illustrated in FIG. 7C, the intensity distribution of the light incident on the sensor panel DD is varied depending on the position in the first direction X.

The intensity of the light incident on the sensor panel DD is also varied depending on the position in the second direction Y. When the direction X and the direction Y are replaced in FIG. 6, it can be understood that the light intensity is varied depending on the position in the second direction Y.

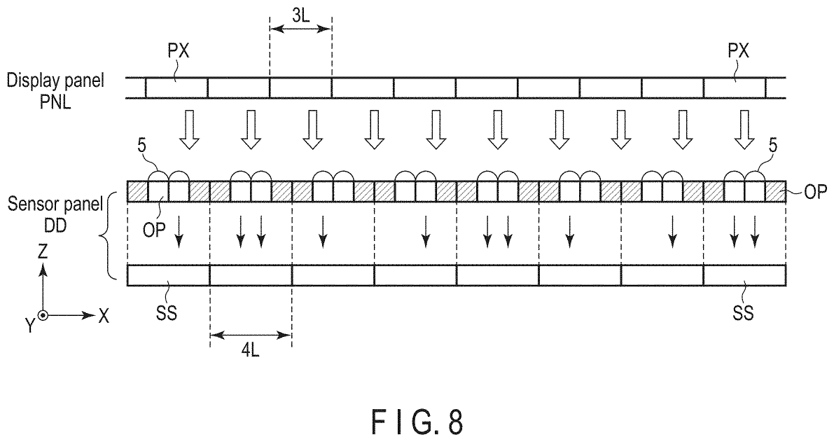

FIG. 8 is a schematic cross-sectional view illustrating a second example of the intensity distribution of the incident light in a case where the arrangement cycle of the pixels PX is different from the arrangement cycle of the sensor elements SS. FIG. 8 exemplarily illustrates that the intensity of the light incident on the sensor panel DD is varied depending on the position in the first direction X. The intensity of the light incident on the sensor panel DD is also varied similarly depending on the position in the second direction Y.

In the second example, the configuration of the sensor elements SS is different from that illustrated in FIG. 3. Two lenses 5 are-arranged along the first direction X for each sensor element SS. The number of lenses 5 arranged along the second direction Y for each sensor element SS is any number. The two lenses 5 arranged along the first direction X are arranged in the center of the sensor element SS. Two openings OP are arranged at positions corresponding to the two lenses 5, respectively, at the collimator CL. The openings OP are also arranged in the center of the sensor element SS.

Similarly to FIG. 6, the two adjacent pixels PX are spaced apart, the two adjacent lenses 5 are spaced apart, the two adjacent openings OP are spaced apart, and the two adjacent sensor elements SS are spaced apart.

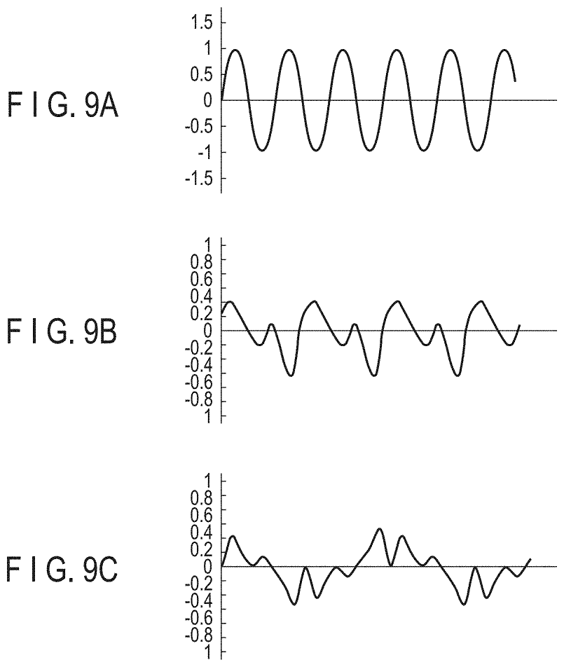

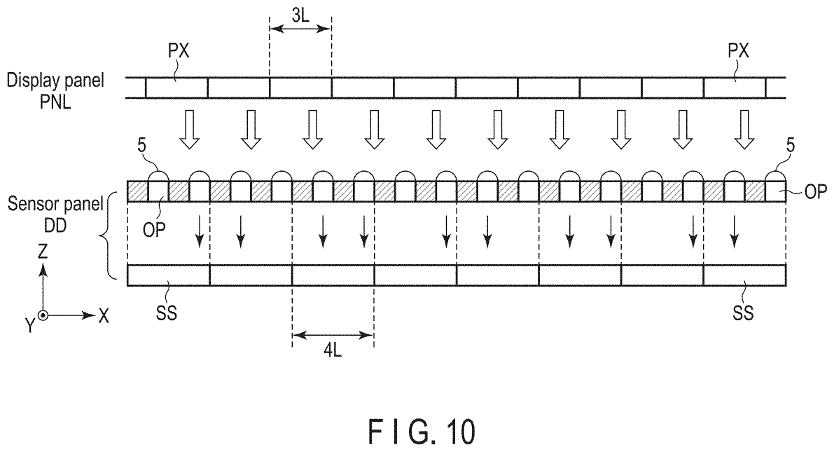

FIG. 9A, FIG. 9B, and FIG. 9C are waveform charts illustrating a second example of the intensity distribution of the incident light in a case where the pixels PX and the sensor elements SS are arranged as illustrated in FIG. 8. In FIG. 9A, FIG. 9B, and FIG. 9C, the vertical axis indicates the light intensity and the horizontal axis indicates the position in the first direction X. FIG. 9A is a chart illustrating the intensity variation of the light transmitted through the display panel PNL. FIG. 9B is a chart illustrating the light transmittance of the collimator CL alone. FIG. 9C is a chart illustrating the intensity variation of the light incident on the sensor elements SS. As illustrated in FIG. 9C, the intensity distribution of the light incident on the sensor panel DD is varied depending on the position in the first direction X. However, the difference in variation of the light intensity distribution illustrated in FIG. 9C is smaller than that in FIG. 7C. In other words, the degree of interference of the pixels PX and the sensor elements SS can be lowered and the periodic noise can be reduced by changing the arrangement pattern of the lenses 5 and the arrangement pattern of the openings OP in the sensor elements SS.

The intensity of the light incident on the sensor panel DD is also varied depending on the position in the second direction Y. When the direction X and the direction Y are replaced in FIG. 8, it can be understood that the light intensity is varied depending on the position in the second direction Y.

FIG. 10 is a schematic cross-sectional view illustrating a third example of the intensity distribution of the incident light in a case where the arrangement cycle of the pixels PX is different from the arrangement cycle of the sensor elements SS. FIG. 10 exemplarily illustrates that the intensity of the light incident on the sensor panel DD is varied depending on the position in the first direction X. The intensity of the light incident on the sensor panel DD is also varied similarly depending on the position in the second direction Y.

In the third example, the configuration of the sensor elements SS is different from that illustrated in FIG. 3. Two lenses 5 are arranged along the first direction X for each sensor element SS. Unlike the case in FIG. 8, however, the two lenses 5 arranged along the first direction X are arranged discretely in the area of the sensor elements SS. Two openings OP are arranged at positions corresponding to the two lenses 5, respectively, at the collimator CL. The openings OP are also arranged discretely in the area of the sensor elements SS.

Similarly to FIG. 6, the two adjacent pixels PX are spaced apart, and the two adjacent sensor elements SS are spaced apart.

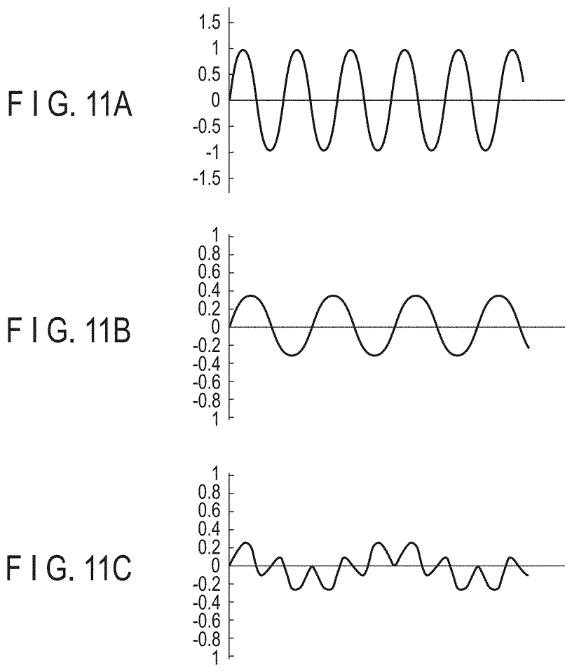

FIG. 11A, FIG. 11B, and FIG. 11C are waveform charts illustrating a third example of the intensity distribution of the incident light in a case where the pixels PX and the sensor elements SS are arranged as illustrated in FIG. 10. In FIG. 11A, FIG. 11B, and FIG. 11C, the vertical axis indicates the light intensity and the horizontal axis indicates the position in the first direction X. FIG. 11A is a chart illustrating the intensity variation of the light transmitted through the display panel PNL. FIG. 11B is a chart illustrating the light transmittance of the collimator CL alone. FIG. 11C is a chart illustrating the intensity variation of the light incident on the sensor elements SS.

As illustrated in FIG. 11C, the intensity distribution of the light incident on the sensor panel DD is varied depending on the position in the first direction X. However, the difference in variation of the light intensity distribution illustrated in FIG. 11C is smaller than that in FIG. 9C. In other words, the degree of interference of the pixels PX and the sensor elements SS can be lowered and the periodic noise can be further reduced by changing the arrangement pattern of the lenses 5 and the arrangement pattern of the openings OP in the sensor elements SS to discrete patterns.

The intensity of the light incident on the sensor panel DD is also varied depending on the position in the second direction Y. When the direction X and the direction Y are replaced in FIG. 10, it can be understood that the light intensity is varied depending on the position in the second direction Y.

Furthermore, if the arrangement of the lenses 5 and the openings OP in one sensor panel DD is a combination of the arrangements illustrated in FIG. 6, FIG. 8, and FIG. 10, cycles of the arrangements of the lenses 5 occur and cycles of the arrangements of the openings OP occur. The intensity variation of the input light to the sensor elements SS is suppressed, and the periodic noise can be further reduced. The arrangement pattern of the first embodiment based on a combination of the arrangements of FIG. 6, FIG. 8, and FIG. 10 will be described below.

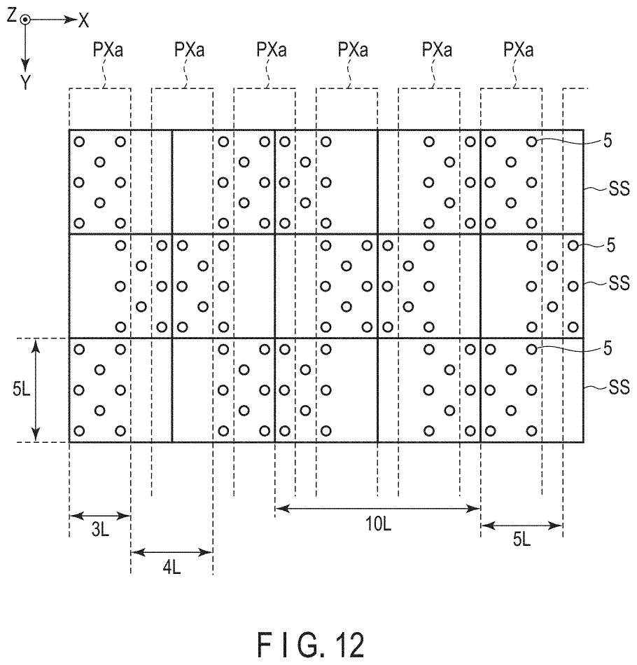

FIG. 12 is a plan view illustrating a first example of the arrangement pattern of the lenses 5 in the optical sensor 100 according to the first embodiment. The shape of the sensor element SS is a substantially square shape and its size is set to 5L in both the first direction X and the second direction Y. The sensor elements SS are arrayed two-dimensionally in the first direction X and the second direction Y. In the two-dimensionally arrayed sensor elements SS, a set of sensor elements SS along the first direction X is referred to as a row of sensor elements SS and a set of sensor elements SS along the second direction Y is referred to as a column of sensor elements SS.

For convenience of illustration, the sensor elements SS are adjacent to each other in the first direction X and the second direction Y, but, actually, two adjacent sensor elements SS are spaced apart in the first direction X and the second direction Y, as illustrated in FIG. 1.

The shape of the pixel PX is a rectangular shape and its size is set to 3L in the first direction X and 5L in the second direction Y.

The pixels PX are also arrayed two-dimensionally in the first direction X and the second direction Y. A set of pixels PX in the second direction Y is referred to as a column of pixels PXa. For convenience of illustration, the pixels PX are adjacent to each other in the second direction Y, but, actually, two adjacent pixels PX are also spaced apart in the second direction Y as illustrated in FIG. 1.

In one sensor element SS, eight lenses 5 are arranged closely to one side in the first direction X (see FIG. 3). The manner of arranging the lenses in an odd-numbered column, of eight lenses 5 in one sensor element SS, is different from that in an even-numbered column. The manner of arranging the lenses in an odd-numbered row is different from that in an even-numbered row in the same column. The top row of sensor elements SS in FIG. 12 is referred to as the first row, and the leftmost column of sensor elements SS in FIG. 12 is referred to as the first column.

In the odd-numbered columns (odd columns), the lenses 5 are arranged closely to the first side S1 (left side in FIG. 12) of the sensor elements SS of the odd-numbered rows (odd rows), and the lenses 5 are arranged closely to the second side S2 (right side in FIG. 12) of the sensor elements SS of the even-numbered rows (even rows).

In the even-numbered columns (even columns), the lenses 5 are arranged closely to the second side S2 (right side in FIG. 12) of the sensor elements SS of the odd-numbered rows, and the lenses 5 are arranged closely to the first side S1 (left side in FIG. 12) of the sensor elements SS of the even-numbered rows.

In the odd-numbered rows, sixteen lenses 5 of the sensor elements SS in the 2i-th column and the (2i+1)-th column are continuously arranged together. Eight lenses 5 of the sensor elements SS in the i-th column and eight lenses 5 of the sensor elements SS in the (i+1)-th column are arranged separately by 4L. i is any positive integer.

In the even-numbered rows, sixteen lenses 5 of the sensor elements SS in the 2i-th column and the (i+1)-th column are continuously arranged together. Eight lenses 5 of the sensor elements SS in the 2i-th column and eight lenses 5 of the sensor elements SS in the (2i+1)-th column are arranged separately by 4L.

In the sensor elements SS in each row, a set of sixteen lenses 5 of the sensor elements SS in the 2i-th column and the (2i+1)-th column are arranged in a cycle of 10L. A set of sixteen lenses 5 in the sensor elements SS in the odd-numbered rows and a set of sixteen lenses 5 in the sensor elements SS in the even-numbered rows are displaced by 5L in the first direction X. In other words, the arrangements of the sets of sixteen lenses in a cycle of 10L are displaced by half a cycle between the odd and even rows. The intensity distribution of the light incident on the sensor panel DD is widened in the first direction X.

In other words, the set of sixteen lenses 5 are arranged two-dimensionally in a first oblique direction that is oblique to the first direction X and a second oblique direction that is oblique to the second direction Y, on the sensor panel DD. On the display panel PNL, the pixels PX are arrayed in a two-dimensional matrix in the first direction X and the second direction Y. The wirings on the display panel PNL are aligned along the array of pixels PX and the wirings on the sensor panels SS are aligned along the lenses 5. Angles of both wirings are different from each other. The degree of interference caused by the difference between the arrangement cycle of the sensor elements SS and the arrangement cycle of the pixels PX can be lowered. If the shadow of the wirings on the display panel PNL is detected at the same position in each row, the shadow may occur periodically.

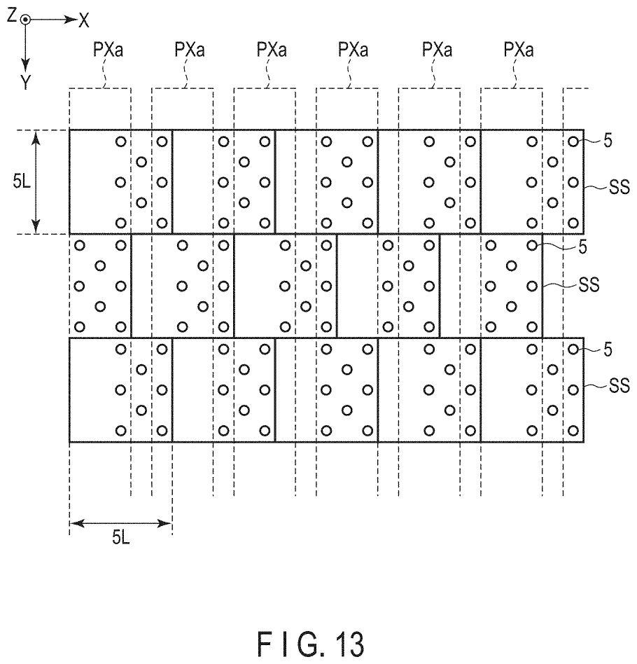

FIG. 13 is a plan view illustrating a second example of the arrangement pattern of the lenses 5 in the optical sensor 100 according to the first embodiment.

The shape and size of the sensor elements SS and the shape and size of the pixels PX are the same as those in the first example illustrated in FIG. 12.

In one sensor element SS, eight lenses 5 are arranged closely to one side in the first direction X (see FIG. 3), similarly to the first example. Unlike the first example, however, the manner of arranging the lenses 5 closely to one side is the same in all the sensor elements SS. For example, the lenses 5 are arranged closely to the second side S2 of the sensor element SS in FIG. 3 (the right side in FIG. 13).

The shape and size of the sensor element SS are the same as the shape and size of the sensor element SS in the first example illustrated in FIG. 12. The arrangement pattern of the sensor elements SS is different from that of the first example illustrated in FIG. 12. The center position of sensor element SS in the first direction X is the same in each row, in the first example illustrated in FIG. 12. In the example illustrated in FIG. 13, the cycles of the sensor elements SS are the same in the odd-numbered rows and even-numbered rows. The center positions the sensor elements SS in the first direction X are shifted. In other words, the arrangement of the sensor elements SS in the odd-numbered rows is different in phase in the first direction X from that in the even-numbered rows.

In the second example illustrated in FIG. 13, the sensor elements SS are arranged two-dimensionally along directions oblique to the first direction X and the second direction Y. In the first example illustrated in FIG. 12, the sensor elements SS are arranged along the first direction X and the second direction Y, similarly to the pixels PX.

The center positions, i.e., phases, of the sensor elements SS in the first direction X is shifted for each row. A set of eight lenses 5 (i.e., sensor elements SS) are arranged in a two-dimensional matrix along a direction oblique to the first direction X and a direction oblique to the second direction Y, in the sensor panel DD, similarly to the first example illustrated in FIG. 12. On the display panel PNL, the pixels PX are arrayed in a two-dimensional matrix in the first direction X and the second direction Y. Since the angle between the matrix of the pixels PX and the matrix of the lenses 5 is shifted, the degree of interference caused by the difference between the arrangement cycle of the sensor elements SS and that of the pixels PX can be lowered.

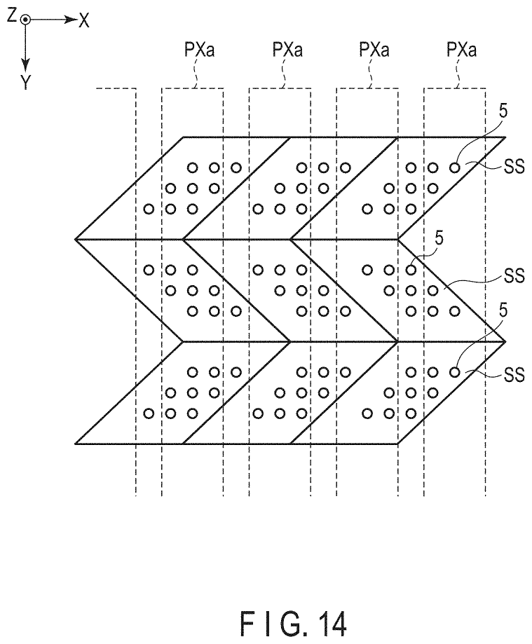

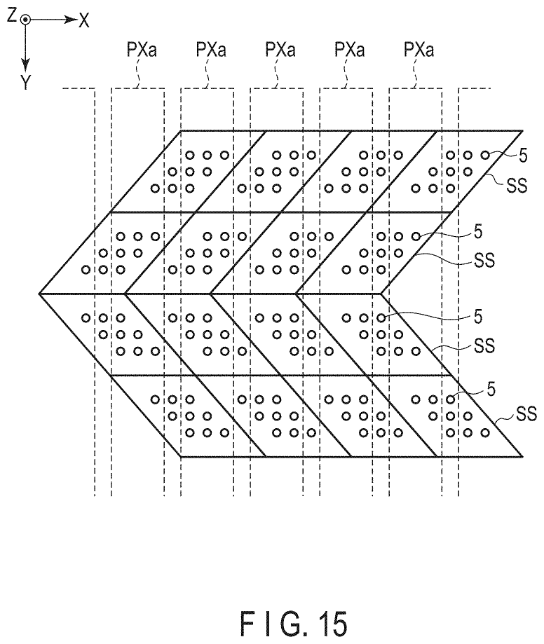

FIG. 14 is a plan view illustrating a third example of the arrangement pattern of the lenses 5 in the optical sensor 100 according to the first embodiment.

In the sensor panel DD, sensor elements SS having the same position in the first direction X in each row are connected to the controller CT via a wiring WL1 (see FIG. 2). In the examples of FIG. 12 and FIG. 13, the wiring WL1 is a straight wiring along the second direction Y. In the third example in FIG. 14, the wiring WL1 is formed in a zigzag pattern for sensor elements SS in one row. For example, the wiring WL1 is formed along a line from the upper right to the lower left for the sensor elements SS in the odd-numbered rows. The wiring WL1 is formed along a line from the upper left to the lower right for the sensor elements SS in the even-numbered rows. In this case, the planar shape of the sensor element SS is not a substantially square shape, but a rhombus or parallelogram. The two-dimensionally arrayed sensor elements SS are bent in a wedge shape for each row. In the examples in FIG. 1 to FIG. 13, the first number (=8) of lenses 5 are arranged for one sensor element SS. In the example of FIG. 14, the first number (=9) of lenses 5 in three rows and three columns are arranged for one sensor element SS.

According to the arrangement pattern of the sensor elements SS, the arrangement pattern of the lenses 5 in the sensor element SS also bends in a wedge shape for each row. By arranging the lenses 5 in a wedge shape for each row of the sensor elements SS, the number of lenses 5 for each pixel Pxa in each row is approximately equal to each other. The intensity of the incident light on the sensor panel DD can be prevented from being periodically varied in the first direction X and periodic noise can be prevented from occurring in the image.

FIG. 15 is a plan view illustrating a fourth example of the arrangement pattern of the lenses 5 in the optical sensor 100 according to the first embodiment.

In the fourth example, too, the wiring WL1 is formed in a zigzag manner, similarly to the third example illustrated in FIG. 14. The cycle of the zigzag is one row of sensor elements SS in the third example. The cycle of the zigzag is two or more rows of sensor elements SS in the fourth example. The fourth example is different from the third example only in the zigzag cycle. By arranging the lenses 5 in a wedge shape for rows of sensor elements SS, the number of lenses 5 for each pixel Pxa in each row is further approximately equal to that in the third example, such that the intensity of the incident light on the sensor panel DD can be prevented from being periodically varied in the first direction X and the periodic noise can be prevented from occurring in the image.

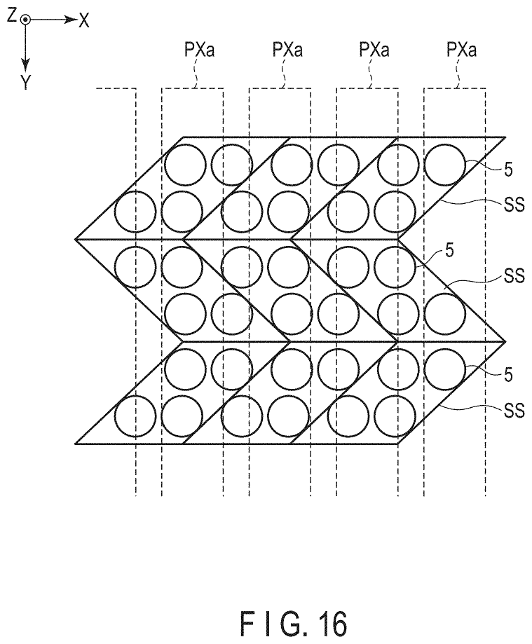

FIG. 16 is a plan view illustrating a fifth example of the arrangement pattern of the lenses 5 in the optical sensor 100 according to the first embodiment. The example in FIG. 16 is different from the third example of FIG. 14 in the diameter of the lens 5 and the number of lenses 5. In the fifth example, the diameter of the lens 5 is larger than that in the third example, and the number of lenses 5 to be arranged is reduced accordingly. The fifth example includes a case where the number of lenses 5 for the sensor element SS is one. In the example of FIG. 16, the intensity of the incident light of the sensor element SS is increased since the angle of capturing the reflected light is large.

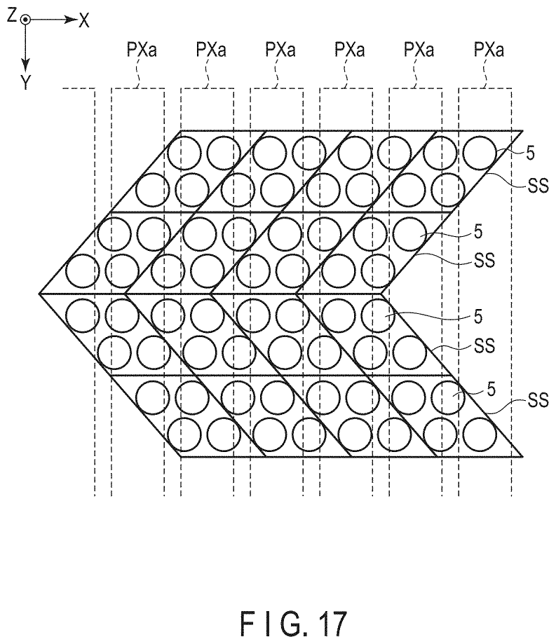

FIG. 17 is a plan view illustrating a sixth example of the arrangement pattern of the lenses 5 in the optical sensor 100 according to the first embodiment. The example of FIG. 16 is different from the fourth example of FIG. 15 in the diameter of the lens 5 and the number of lenses 5. In the sixth example, the diameter of the lens 5 is larger than that in the fourth example, and the number of lenses 5 to be arranged is reduced accordingly. The sixth example illustrates an example where the first number (=4) of lenses 5 are arranged for one sensor element SS. The first number is not limited to four, but may be smaller than that in the fourth or fifth example. The sixth example includes a case where the number of lenses 5 for one sensor element SS is one.

According to the first embodiment, periodic noise is prevented from occurring in the image since the pixels PX and the lenses 5 are arranged such that directions of their arrangement do not correspond to each other.

### Second Embodiment

In the first embodiment, the arrangement of the lenses 5 (and openings OP) that urge light to be incident on, the sensor elements SS is different for each sensor element SS. The arrangement direction of the pixels PX can be made different from that of the lenses 5. Occurrence of the periodic noise in the image can be prevented.

In the second embodiment, the arrangement of lenses 5 (and openings OP) is the same for all sensor elements SS. Light made incident on a sensor panel is scattered. Occurrence of periodic noise in the image is prevented even if the arrangement period of pixels PX is the same as that of the sensor elements SS.

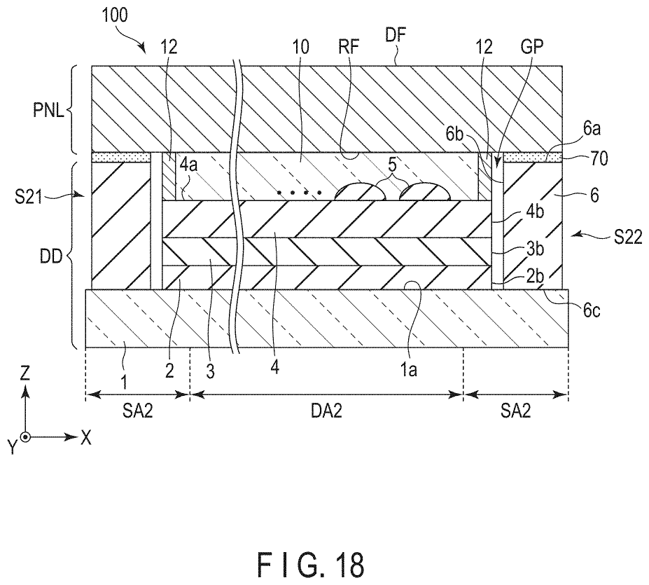

FIG. 18 is a cross-sectional view illustrating an example of a schematic configuration along an X-Z plane of an optical sensor 100 according to the second embodiment. The same elements as those of the optical sensor 100 of the first embodiment are denoted by the same reference numerals and their detailed description is omitted. In the optical sensor 100 of the second embodiment, the space SP (FIG. 5) between the collimator layer 4 and the display panel PNL is filled with a spacer 12. The spacer 12 is formed of, for example, an organic material and has insulating properties. The spacer 12 is arranged inside the spacer 6, which is arranged in the peripheral area SA2 of the sensor panel DD, and in the periphery of the collimator layer 4.

A light scattering layer 10 is provided on the collimator layer 4 inside the spacer 12. The light scattering layer 10 is arranged in the space surrounded by the collimator layer 4, the display panel PNL, and the spacer 12. Examples of the light scattering layer 10 are a light scattering film, an adhesive with a light scattering material, and the like.

According to the second embodiment, the light made incident on the sensor panel DD from the display panel PNL by scattered. The light scattering layer 10 reduces the intensity of the light incident on the sensor panel DD. Occurrence of periodic noise in the image can be prevented even when the arrangement cycle of the pixels PX is the same as that of the sensor elements SS. Since the resolution of fingerprint recognition is deteriorated as the degree of scattering increases, the degree of scattering is set within a range that does not make the resolution of fingerprint recognition deteriorated. For example, the particle size of the light scattering layer 10 is determined by considering the transmittance and scattering.

### Third Embodiment

The sensor panel DD can detect fingerprints based on detection signals of sensor elements SS. The sensor panel DD cannot distinguish a fake finger having the same pattern as the fingerprint from a human finger. Next, a third embodiment for distinguishing a fake from a human finger will be described. It is known that when human skin is pressed its surface color changes (for example, becomes white). For this reason, if the color change over time (whitening) at the time when a finger is pressed against the display panel PNL is used, a fake can be distinguished from a human finger. The sensor panel DD determines whether a change over time in the color of the image, i.e., whitening occurs after a finger is pressed against the display panel PNL. When detecting whitening of the image, the sensor panel DD determines that it is human skin that is pressed against the display panel PNL, and detects a fingerprint. When not detecting whitening, the sensor panel DD determines that a fake is pressed against the display panel PNL, and stops the process at that point.

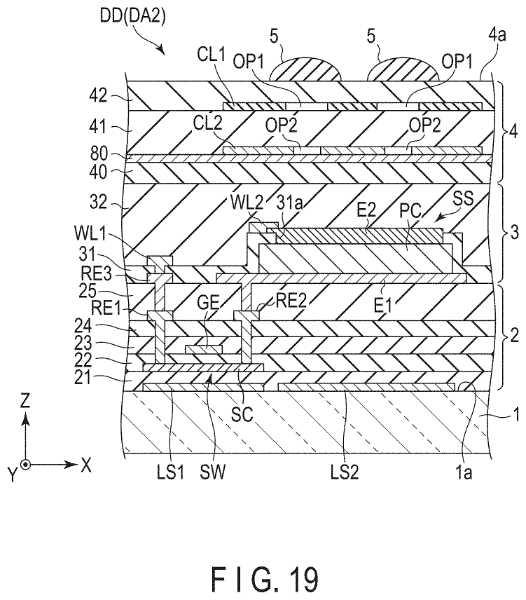

FIG. 19 is a cross-sectional view illustrating an example of the sensor panel DD according to the third embodiment. The same elements as those of the sensor panel DD of the first embodiment illustrated in FIG. 2 are denoted by the same reference numerals and their detailed description is omitted.

In the collimator layer 4, a color filter layer 80 is stacked on or under the collimator CL2 (under the collimator CL2 in FIG. 19). The color filter layer 80 includes a red filter that allows a red component to be transmitted, a blue filter that allows a blue component to be transmitted, and a transparent filter that allows all color components to be transmitted. The red filter, the blue filter, or the transparent filter is arranged for each sensor element SS. The light of the red component is made incident on the sensor element SS in which the red filter is arranged. The light of the blue component is made incident on the sensor element SS in which the blue filter is arranged. Since a cut layer 40 is arranged under the color filter layer 80, the light with a wavelength of 650 nm or less transmitted through the cut layer 40 is made incident on the sensor element SS in which the transparent filter is arranged. The light having a wavelength of approximately 480 nm to 650 nm, i.e., light including a green component, which is obtained by adjusting the cutoff wavelength of the cut layer 40, may be made incident on the sensor element.

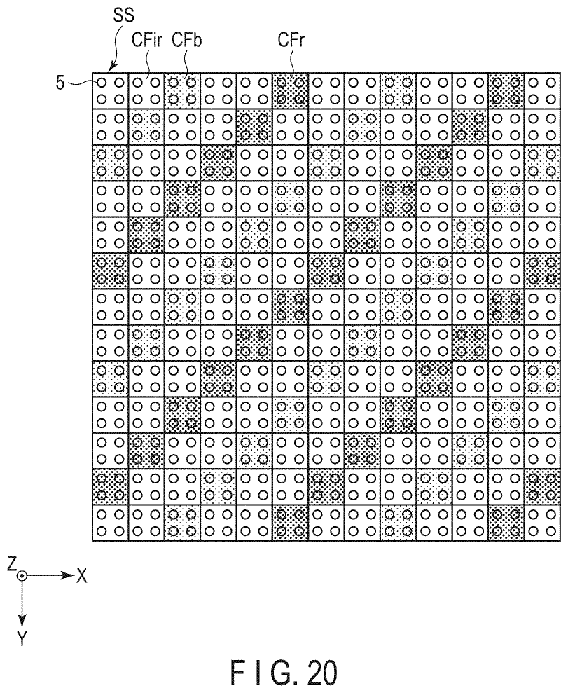

FIG. 20 is a plan view illustrating a first example of the arrangement of the color filters in the color filter layer 80 in the sensor panel DD according to the third embodiment. In the third embodiment, the color filters of different colors are arranged for each sensor element SS.

FIG. 20 illustrates an example in which the first number (=4) of lenses 5 are arranged for one sensor element SS for convenience of illustration. There are no restrictions on the number or arrangement of the lenses 5. The number and arrangement are set arbitrarily. Eight lenses may be arranged similarly to the first and second examples or nine lenses may be arranged similarly to the third and fourth examples of the first embodiment, for one sensor element SS. The sensor elements SS are arrayed in a two-dimensional matrix along the first direction X and the second direction Y. There is no restriction on the arrangement of the pixels PX. The pixels PX may be arranged in a direction aligned with the arrangement direction of the sensor elements SS similarly to the conventional example or may be arranged in a direction different from the arrangement direction of the sensor elements SS similarly to the first embodiment.

A red filter CFr is arranged for each predetermined number of sensor elements SS in the row direction and the column direction. A blue filter CFb is arranged between adjacent two of the red filters CFr. For example, the blue filter CFb is arranged in the middle of the two red filters CFr in the row direction and the column direction. The transparent filters are arranged in the sensor elements SS in which neither the red filters CFr nor the blue filters CFb are arranged. For example, in the sensor elements SS in the first row, the red filters CFr are arranged in the sixth sensor element and the twelfth sensor element from the left. The blue filters CFb are arranged in the third sensor element and the ninth sensor element from the left. The transparent filters are arranged in the other sensor elements. The sensor elements SS where the transparent filters are arranged are equivalent to sensor elements in which infrared (IR) cut filters CFir are arranged. The IR cut filter CFir allows light of the green component to be transmitted due to the presence of the cut layer 40. The sensor element in which the transparent filter is arranged is hereinafter referred to as a sensor element in which the IR cut filter CFir is arranged.

In the sensor elements SS in the second and subsequent rows from the top, the positions of the sensor elements SS in which the red filters CFr and the blue filters CFb are arranged are shifted to the left by one element. The sensor elements SS in which the red filters CFr and the blue filters CFb are arranged are arrayed along a 45-degree diagonal line from the top right to the bottom left of the sensor panel DD. In each row of sensor elements SS, an interval in the first direction X between two sensor elements SS in which the red filters CFr are arranged is the size of six sensor elements SS. An interval in the first direction X between two sensor elements SS in which the blue filters CFb are arranged is the size of six sensor elements SS. In each row of sensor elements SS, an interval in the first direction X between the sensor in which the red filter CFr is arranged and the sensor in which the red filter CFb is arranged is the size of three sensor elements SS.

Similarly, in the sensor elements SS in the first left column, the red filters CFr are arranged in the sixth sensor element and the twelfth sensor element from the top. The blue filters CFb are arranged in the third sensor element and the ninth sensor element from the top. The IR cut filters CFir are arranged in the other sensor elements SS.

In the sensor elements SS in the second and subsequent columns from the left, the positions of the sensor elements SS in which the red filters CFr and the blue filters CFb are arranged are shifted to the top by one element. In each column of sensor elements SS, an interval in the second direction Y between two sensor elements SS in which the red filters CFr are arranged is the size of six sensor elements SS. An interval in the second direction Y between two sensor elements SS in which the blue filters CFb are arranged is the size of six sensor elements SS. In each column of sensor elements SS, an interval in the second direction Y between the sensor in which the red filter CFr is arranged and the sensor in which the red filter CFb is arranged is the size of three sensor elements SS.

According to the color filter arrangement pattern in FIG. 20, the number of sensor elements SS in which the red filters CFr are arranged and the number of sensor elements SS in which the blue filters CFb are arranged is smaller than the number of sensor elements SS in which the IR cut filters CFir are arranged. The color components of the light intensity reaching the sensor elements SS, especially the red and blue components, become small. The positions of the sensor elements SS detecting the red and blue components are shifted for each row. The periodicity of the intensity variation of the light incident on the sensor elements SS is weakened and the periodic noise is reduced.

In FIG. 20, the direction of shifting the positions of the sensor elements SS detecting the same color components for each row may be rightward. The direction of shifting the positions of the sensor elements SS detecting the same color component for each column may be downward. The sensor elements SS detecting the same color components in the sensor panels SS are arranged along a diagonal line from upper left to lower right.

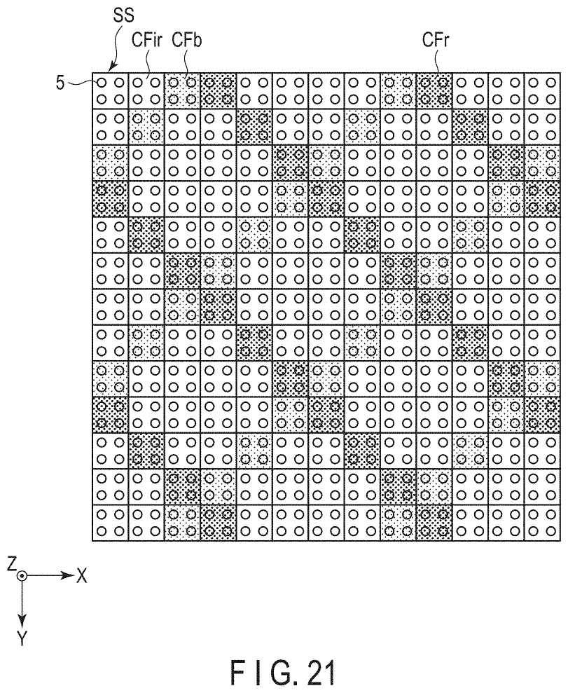

FIG. 21 is a plan view illustrating a second example of the arrangement of the color filters in the color filter layer 80 in the sensor panel DD according to the third embodiment. FIG. 21 illustrates an example in which four lenses 5 are arranged for one sensor element SS. There are no restrictions on the number or arrangement of the lenses 5. The number and arrangement are set arbitrarily. The sensor elements SS are arrayed in a two-dimensional matrix along the first direction X and the second direction Y. There is no restriction on the arrangement of the pixels PX. The pixels PX may be arranged in a direction aligned with the arrangement direction of the sensor elements SS similarly to the conventional example or may be arranged in a direction different from the arrangement direction of the sensor elements SS similarly to the first embodiment.

The red filter CFr is arranged for every predetermined number of sensor elements SS in the row and column directions. The blue filter CFb is arranged at any position between the red filters CFr. The transparent filters are arranged in the sensor elements SS in which neither the red filters CFr nor the blue filters CFb are arranged. For example, in the sensor elements SS in the first row, the red filters CFr are arranged in the fourth sensor element and the tenth sensor element from the left. The blue filters CFb are arranged in the third sensor element and the ninth sensor element from the left. The IR cut filters CFir are arranged in the other sensor elements SS.

In the sensor elements SS in the second and subsequent rows from the top, the positions of the sensor elements SS in which the blue filters CFb are arranged are shifted to the left by one element, and the positions of the sensor elements SS in which the red filters CFr are arranged are shifted to the right by one element. The sensor elements SS in which the blue filters CFb are arranged are arrayed along a 45-degree diagonal line from the top right to the bottom left of the sensor panel DD. The sensor elements SS in which the red filters CFr are arranged are arrayed along a 45-degree diagonal line from the top left to the bottom left of the sensor panel D. In each row of sensor elements SS, an interval in the first direction X between two sensor elements SS in which the red filters CFr are arranged is the size of six sensor elements SS. An interval in the first direction X between two sensor elements SS in which the blue filters CFb are arranged is the size of six sensor elements SS. In each row of sensor elements SS, an interval in the first direction X between the sensor in which the red filter CEr is arranged and the sensor in which the blue filter CFb is arranged on the right side of the red filter CFr is varied in each row. An interval in the first direction X between the sensor in which the red filter CFr is arranged and the sensor in which the blue filter CFb is arranged on the left side of the red filter CEr is varied in each row.

Similarly, in the sensor elements SS in the first left column, the red filters CFr are arranged in the fourth sensor element and the tenth sensor element from the top. The blue filters CFb are arranged in the third sensor element and the ninth sensor element from the top. The IR cut filters CFir are arranged in the other sensor elements SS.

In the sensor elements SS in the second and subsequent columns from the left, the positions of the sensor elements SS in which the blue filters CFb are arranged are shifted to the top by one element. The positions of the sensor elements SS in which the red filters CFr are arranged are shifted to the bottom by one element. In each column of sensor elements SS, an interval in the second direction Y between two sensor elements SS in which the red filters CFr are arranged is the size of six sensor elements SS. An interval in the second direction Y between two sensor elements SS in which the blue filters CFb are arranged is the size of six sensor elements SS. In each column of sensor elements SS, an interval in the second direction Y between the sensor element in which the red filter CFr is arranged and the sensor element in which the blue filter CFb is arranged on the upper side of the red filter CFr is varied in each column. An interval in the second direction Y between the sensor element in which the red filter CFr is arranged and the sensor element in which the blue filter CFb is arranged on the lower side of the red filter CFr is varied in each column.

The color filter layer 80 illustrated in FIG. 21 also has the same effects as the color filter layer 80 illustrated in FIG. 20.

In FIG. 21, the direction of shifting the sensor elements SS that detect the same color component in each row may be opposite to the above. In this case, the sensor elements SS in which the blue filters CFb are arranged are arrayed along a 45-degree diagonal line from the top left to the bottom right of the sensor panel DD. The sensor elements in which the red filters CFr are arranged is arrayed along a 45-degree diagonal line from the top right to the bottom left of the sensor panel DD.

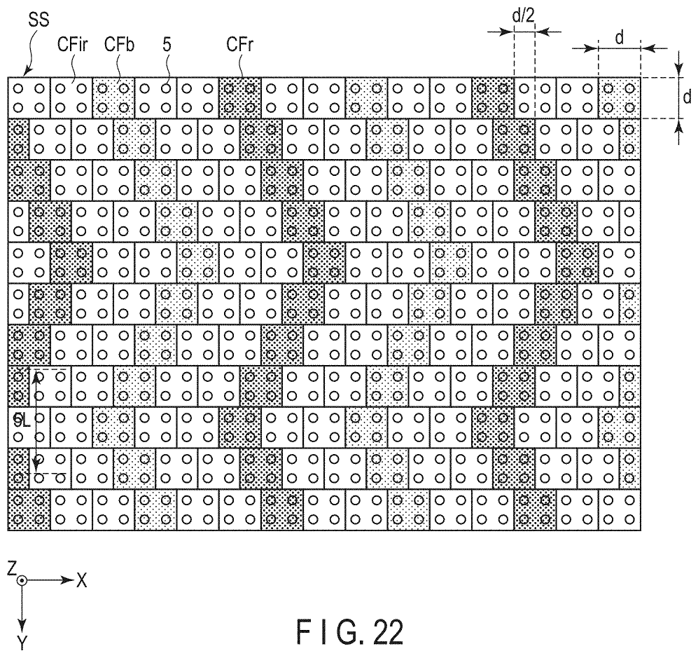

FIG. 22 is a plan view illustrating a third example of the arrangement of the color filters in the color filter layer 80 in the sensor panel DD according to the third embodiment. FIG. 22 illustrates an example in which four lenses 5 are arranged for one sensor element SS. There are no restrictions on the number or arrangement of the lenses 5. The number and arrangement are set arbitrarily. There is no restriction on the arrangement of the pixels PX. The pixels PX may be arranged in a direction aligned with the arrangement direction of the sensor elements SS similarly to the conventional example or may be arranged in a direction different from the arrangement direction of the sensor elements SS similarly to the first embodiment.

With respect to the arrangement of the sensor elements SS, the center positions of the sensor elements SS in the first direction X are shifted in each row. It is assumed that the size of sensor element SS in each of the first direction X and the second direction Y is referred to as d. The center position in the first direction X of the sensor element SS in the second row from the top is shifted to the right side by d/2 from the center position in the first direction X of the sensor element SS in the first row. Similarly, the center positions of the sensor elements SS in the first direction X in each row are hereinafter shifted to the right side by d/2 from the center positions in the first direction X of the sensor elements SS in an upper row from the row. The direction of shifting is reversed every few rows (five rows in the example in FIG. 22). In other words, the center positions in the first direction X of the sensor elements SS in the sixth row from the top are shifted to the left side by d/2 from the center positions in the first direction X of the sensor elements SS in the fifth row from the top. The directions of arrangement of the sensor elements SS are not the first direction X and the second direction Y, but two directions, i.e., the first direction X and a direction oblique to the second direction Y.

The red filter CFr is arranged for every predetermined number of sensor elements SS in the row direction. The blue filter CFb is arranged between adjacent two of the red filters CFr in the row direction. The blue filter CFb may be arranged halfway between the red filters CFr in the row direction. The transparent filters are arranged in the sensor elements SS in which neither the red filters CFr nor the blue filters CFb are arranged. In FIG. 22, in the sensor elements SS in the first row, the red filters CFr are arranged in the sixth sensor element and the twelfth sensor element from the left. The blue filters CFb are arranged in the third sensor element, the ninth sensor element, and the fifteenth sensor element from the left. The IR cut filters CFir are arranged in the other sensor elements SS.

The center positions in the first direction X of the sensor elements SS in which the red filters CFr and the blue filters CFb are arranged in the second row from the top are shifted to the right side by d/2 from the center positions in the first direction X of the sensor elements SS in which the red filters CFr and the blue filters CFb are arranged in the first row. Similarly, the center positions in the first direction X of the sensor elements SS in which the red filters CFr and the blue filters CFb are arranged in each row are shifted to the right side by d/2 from the center positions in the first direction X of the sensor elements SS in which the red filters CFr and the blue filters CFb are arranged in an upper row from the row.

The direction of shifting is reversed every five rows. In other words, the center positions in the first direction X of the sensor elements SS in which the red filters CFr and the blue filters CFb are arranged in the sixth row from the top are shifted to the left side by d/2 from the center positions in the first direction X of the sensor elements SS in which the red filters CFr and the blue filters CFb are arranged in the fifth row.

In each row of sensor elements SS, an interval in the first direction X between two sensor elements SS in which the red filters CFr are arranged is the size of six sensor elements SS. An interval in the first direction X between two sensor elements SS in which the blue filters CFb are arranged is the size of six sensor elements SS. In each row of sensor elements SS, an interval in the first direction X between the sensor element in which the red filter CFr is arranged and the sensor element in which the red filter CFb is arranged is the size of three sensor elements SS.

The color filter layer 80 illustrated in FIG. 22 also has the same effects as the color filter layer 80 illustrated in FIG. 20.

According to the third embodiment, each sensor element SS detects the image signals of the red, blue, and green components. When detecting the change over time in the color of the image signals (whitening), the controller CT detects a fingerprint from the image signals. When not detecting the color change over time (whitening) of the image signals, the controller CT does not execute the fingerprint detection process and ends the sensing operation.

Since the sensor elements SS that detect the same color component are distributed and arranged in a staggered grid in the sensor panel DD, the periodicity of intensity variation of the incident light on the sensor elements SS is weakened and the periodic noise is reduced.

The color filter layer 80 illustrated in FIG. 20 and FIG. 21 may be changed to the color filter layer 80 illustrated in FIG. 22. In other words, in the example of FIG. 20 or FIG. 22, in a certain row of the sensor elements SS, the positions of the sensor elements SS in which the red filters CFr and the blue filters CFb are arranged are not shifted in the same direction from the positions of the sensor elements SS in which the red filters CFr and the blue filters CFb are arranged in an upper row. The positions of the sensor elements SS in which the red filters CFr and the blue filters CFb are arranged may be shifted to the right or left side by a predetermined number of rows after shifted to the left or right side by a predetermined number of rows. Similarly, the example in FIG. 22 may be changed to that in FIG. 20 and FIG. 21. In other words, in the example of FIG. 22, in a certain row of the sensor elements SS, the positions of the sensor elements SS in which the red filters CFr and the blue filters CFb are arranged may be shifted to the right or left side from the positions of the sensor elements SS in which the red filters CFr and the blue filters CFb are arranged in an upper row.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical sensor comprising:
a display panel; and
a sensor panel under at least a part of the display panel, wherein:
the display panel comprises pixels arranged two-dimensionally;
the sensor panel comprises:
a sensor layer including sensor elements arranged two-dimensionally;
a collimator layer on the sensor layer comprising openings; and
lenses on the collimator layer;
a first number of openings in the openings are on one of the sensor elements;
the first number of lenses in the lenses are on the first number of openings; and
the first number of lenses are at positions different for each of the sensor elements.

2. The optical sensor of claim 1, wherein:
a planar shape of the sensor elements is a rectangular shape;
the first number of lenses are arranged closely to one of sides of the sensor elements; and
the side is different for each of the sensor elements.

3. The optical sensor of claim 1, wherein:
a planar shape of the sensor elements is a rectangular shape;
the first number of lenses are closely to a left side of the sensors in odd-numbered columns of odd-numbered rows;
the first number of lenses are closely to a right side of the sensors in even-numbered columns of the odd-numbered rows;
the first number of lenses are closely to a right side of the sensors in odd-numbered columns of even-numbered rows; and
the first number of lenses are closely to a left side of the sensors in even-numbered columns of the even-numbered rows.

4. The optical sensor of claim 1, wherein:
the pixels are arranged in a first direction and a second direction;
the first direction is orthogonal to the second direction;
the sensor elements are arranged in the first direction and a third direction; and
the third direction is different from the first direction.

5. The optical sensor of claim 1, wherein:
a planar shape of the pixels is a rectangular or square shape; and
a planar shape of the sensor elements is a parallelogram.

6. An optical sensor comprising:
a display panel; and
a sensor panel under at least a part of the display panel, wherein:
the display panel comprises pixels arranged two-dimensionally;
the sensor panel comprises:
a sensor layer including sensor elements arranged two-dimensionally;
a collimator layer on the sensor layer comprising openings; and
lenses on the collimator layer;
a first number of openings in the openings are on each of the sensor elements;
the first number of lenses in the lenses are on the first number of openings; and
a light scattering layer is between the display panel and the collimator layer.

7. An optical sensor comprising:
a display panel; and
a sensor panel under at least a part of the display panel, wherein:
the display panel comprises pixels arranged two-dimensionally;
the sensor panel comprises:
a sensor layer including sensor elements arranged two-dimensionally;
a collimator layer on the sensor layer comprising openings for transmitting light of a first color, a second color, or a third color;
a filter layer overlapping the collimator layer comprising areas for transmitting the light of the first color, the second color, or the third color; and
lenses on the collimator layer or the filter layer;
a first number of openings in the openings are on each of the sensor elements;
the first number of lenses in the lenses are on the first number of openings;
the sensor elements are arranged in a first direction and a second direction;
the first direction is orthogonal to the second direction;
the openings for transmitting the light of the first color are arranged in the first direction and a direction different from the second direction; and
the openings for transmitting the light of the second color are arranged in the first direction and a direction different from the second direction.

8. The optical sensor of claim 7, wherein:
the openings for transmitting the light of the first color are arranged in the first direction and a third direction different from the second direction; and
the openings for transmitting the light of the second color are arranged in the third direction.

9. The optical sensor of claim 7, wherein:
the openings for transmitting the light of the first color are arranged in the first direction and a third direction different from the second direction; and
the openings for transmitting the light of the second color are arranged in the third direction and a fourth direction different from the third direction.

10. The optical sensor of claim 7, wherein:
a first part of the openings for transmitting the light of the first color are arranged in the first direction and a third direction different from the second direction;
a second part of the openings for transmitting the light of the first color are arranged in a fourth direction different from the third direction;
a first part of the openings for transmitting the light of the second color are arranged in the first direction and a fifth direction different from the second direction;
a second part of the openings for transmitting the light of the second color are arranged in a sixth direction different from the fifth direction.
